(19) United States
(12) Patent Application Publication
(10) Pub. No.: US 2002/0111838 A1
(43) Pub. Date: Aug. 15, 2002

(54) Web-based system and method for organizational performance analysis

(76) Inventor: Theresa M. Welbourne, Ann Arbor, MI (US)

Correspondence Address: John A. Miller, Esq., Harness, Dickey & Pierce, PLC, P.O. Box 828, Bloomfield Hills, MI, 48303, US

(21) Appl. No.: 09/771,329

(22) Filed: Jan. 26, 2001

(51) Int. Cl. G06F 17/60; G06F 15/16

(52) U.S. Cl. 705/7; 709/201

(57) ABSTRACT

A system and method for predicting and influencing the performance of an organization. The organization initiates a contract with an independent third party, whereby the independent third party sends correspondence linking members to the third party's web site. The third party's web site periodically asks the member a series of questions relating to the member's energy level and issues affecting performance, whereby the member's comments and responses are sent to a database for analysis. Data summaries, predictions, and assessments are made based upon calculations which use the member's responses. Numerous tools are provided to assist in the facilitation of communication and performance improvement within the organization.

### BACKGROUND OF THE INVENTION

1. Field of the Invention

This invention relates generally to the field of organizational performance, and more particularly, to a web-based system and method for predicting and influencing organizational performance.

2. Discussion of the Related Art

Managers and supervisors have several sources of information that help them make decisions about how to run their organization, whether a business, a school, or a government. For most organizations, financial information is prevalent; in manufacturing, add quality and cost data; in marketing and sales, add customer satisfaction data; in schools or governments, add constituent opinion information. In most cases, an attempt is also made to gather information about the issues impacting engaged individuals' ability to perform, usually through an annual survey and/or through other means such as interviews that generally take a snapshot of a single point in time. Another source of performance information is through annual or periodic performance appraisals. This information is focused on assessing individuals' accomplishments and skills, generally against some predefined objectives and expectations. This information is used to provide feedback to the individual about past performance, set future objectives, and, combined across individuals, to understand the skill gaps against current or future planned needs of the organization.

There are several problems with these approaches to gathering organizational performance information. First, a single snapshot does not tell the whole story. Like financial data, it is the change from week-to-week that is meaningful. Second, also like financial data, it is the act of collecting, disseminating, and discussing the data that provides insight. When this is done on an infrequent basis, it does not work. Imagine trying to run an organization only looking at the financials once per year, or even once per quarter. Third, most of the metrics that are used in an annual survey have not been proven to correlate with organizational performance, so interpretation of the data is difficult. Fourth, the typical survey and interview asks mostly predefined questions. There is little room for individuals to describe the issues affecting their performance in their own terms, thereby limiting the quality of the information. Finally, in the case of performance appraisals, the information that may be obtained about issues affecting performance is generally high level versus specific, and past versus present (e.g.—focused on issues affecting one's ability to achieve past goals versus achieve current specific tasks). Thus, there currently exists no good way for management to get regular, actionable data about the people issues affecting the performance of the organization.

What is needed is an effective technique for gathering information about an organization to predict and influence the performance of the organization that does not suffer from the drawbacks discussed above. It is, therefore, an object of the present invention to provide such a technique.

### SUMMARY OF THE INVENTION

In accordance with the teachings of the present invention, the disadvantages and problems associated with organizational performance analysis and methods mentioned above have been substantially reduced or eliminated. In one embodiment of the present invention, a system for facilitating an internal analysis of an organization by use of an independent third party is provided. The system provides a web-based technique for facilitating communication between a first party and the organization, and provides a mechanism for the organization to respond to the first party's concerns. The system also allows for an anonymous exchange of information and ideas between the parties. In this manner, the system monitors, tracks, and communicates the energy and/or enthusiasm level (as opposed to the job satisfaction) of individual employees allowing prediction and influence of the performance of the organization as a whole.

The system further allows a third party to provide responses to concerns of the first party, and further allows the third party to track and categorize comments made by the first party. The third party then is able to predict and influence, by use of the energy level of a number of individuals, the performance of the organization or entity. The system is able to predict turnover, absentee-ism, and can be used as a basis to facilitate communication among organizational members.

The system uses changes in “pulse” to predict organizational problems and recommend changes to organizational structure and personnel. The system generates comparison values using rankings and weights, and compares these values with one or more benchmark values representing surveys of the same or different surveyed members. As a result of the comparisons, the system generates one or more analysis reports concerning the surveyed organization. The third party, managers or consultants can suggest modifications to the organizational surroundings of the surveyed members in order to optimize the pulse and effectiveness of the organization. The pulse assessments may be limited to a select group or groups of workers within an organization or an organization's sub-community, or may be statistically scaled to include members from throughout an organization to predict and influence overall organizational performance.

### BRIEF DESCRIPTION OF THE DRAWINGS

Still other advantages of the present invention will become apparent to those skilled in the art after reading the following specification and by reference to the drawings in which:

FIG. 1 represents an organizational assessment framework of the present invention;

FIG. 2 illustrates the inter-relationships amongst parties within the evaluation framework; and

FIG. 3 shows a typical plot of the “pulse” of an organization over time.

### DETAILED DESCRIPTION OF THE PREFERRED EMBODIMENTS

The block diagram of the system described below, by way of non-limiting example, describes an interaction between a corporate entity such as a corporation or a member structure for an organizational subset of members within a corporation and its members. The current invention is also directly usable by other organizational structures such as universities, government entities, and/or non-profit institutions. Within the organization, the system interrelates communications between a number of parties to fulfill its objectives. The first party is a person who is responding to the questions posed by a third independent party who maintains the confidentiality of the system. The second party is the person who initially requests the survey and is in a position to facilitate responses and actions based upon pulse measurements of the first party. A pulse measurement is defined herein as a metric that is used to track the overall vitality or energy level of the members of an organization. The pulse measures three components of the work environment: the pace of work, efficiency of work, and job satisfaction. It has been found that these three components work together to dramatically influence individual performance and, therefore, the efficiency of an organization.

Pulse responses can be broken down into three (3) general categories: at rest (1.0 to 2.4), aerobic (2.5 to 7.5), and anaerobic (7.6 to 10.0). In the at rest range (1.0 to 2.4), a member is not too busy and is not feeling efficient at work, and as a result is not satisfied with his or her job as they may be otherwise.

An aerobic evaluation (2.5 to 7.5) represents a “healthy” part of the scale. The aerobic values are generally broken down into three specific ranges. A score of 2.5 to 3.5 means that a member is somewhat involved in his/her work, and does not mind being at work. The range of 3.6 to 4.5 means that the member has less free time, although the pace is still slow, and the member feels comfortable with his or her work. A range of 4.6 to 5.5 is a desired activity level with more than adequate time to organize. The member is feeling good about his or her job in the amount and quality of work he or she accomplishes. In the higher end of the aerobic range, the member is making good progress in a high paced work environment. The member feels good about what they are doing. Pulse values of 6.6 to 7.5 shows that a member does not quite have enough resources (time, skills, equipment, cooperation, etc.) to organize and plan the way the member would like. Still, the member is productive and is doing quality work.

The anaerobic range is divided into two primary sections, the pulse score of 7.6 to 8.5 means that a member is experiencing more than the usual workload and/or projects. The member may be overwhelmed, but the high pace feels like a challenge. The member needs more time and/or resources to help get the work done at a high quality level. In the anaerobic “danger” region, pulse of between 8.6 and 10, the member is very overwhelmed by the pace and amount of work. The quality of the work is suffering, and the work may have a negative effect on the member's personal life.

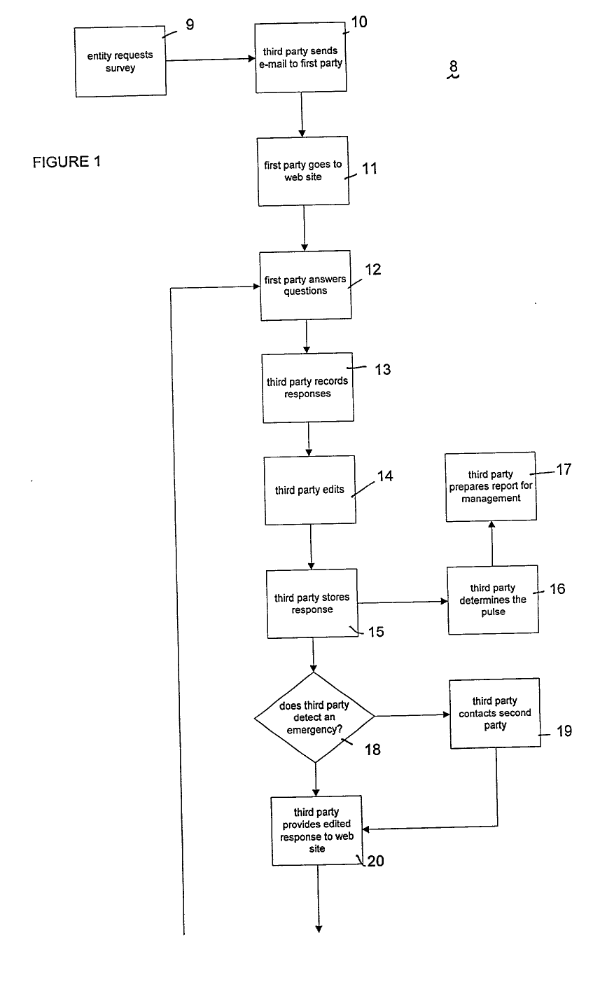

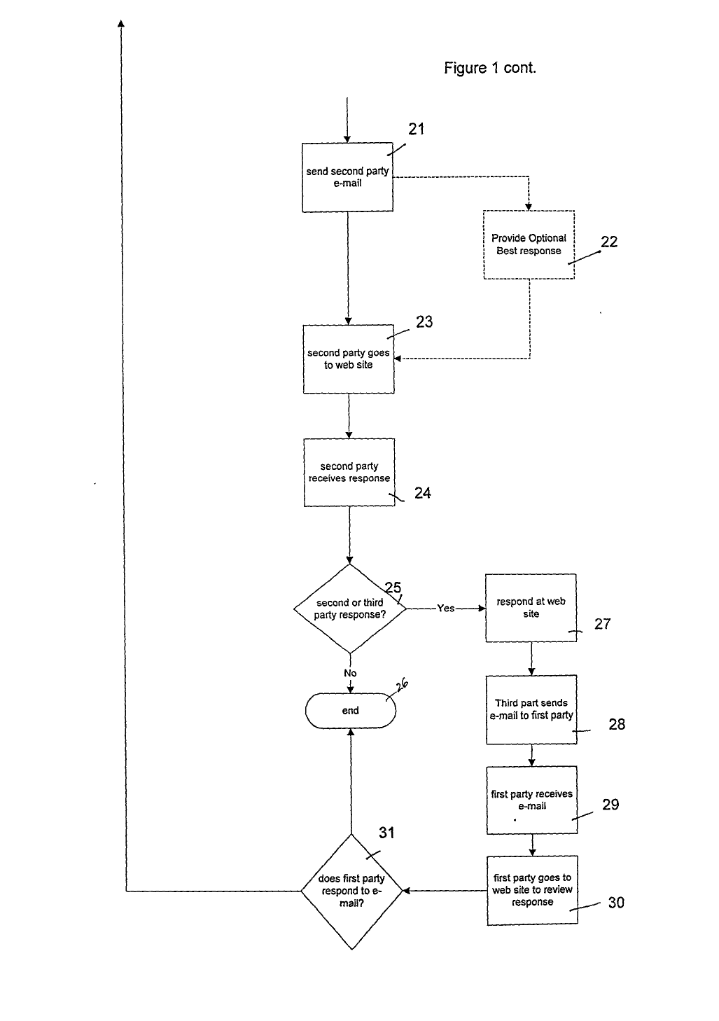

FIG. 1 shows a block diagram of a system, according to an embodiment of the present invention, based around a real-time organization evaluation module 8, which includes one or more algorithms to analyze the vitality of an organization or an individual within a predetermined time set. The algorithms, which are included in the real-time organizational evaluation module 8, may be based on deterministic logic, fuzzy logic, statistical regression analysis, neuro-networks or other optimization techniques, and may use expert systems to analyze and categorize incoming data. The real-time organization evaluation module 8 would also be contained in or have electronic access to a pre-programmed baseline organizational model. Using the decision algorithms it contains, the real-time organizational module 8 receives a request in process block 9 to conduct a survey of the pulse of a group of individuals, or to do an evaluation of an organizational subset within an organization.

In process block 10, the real-time organizational module 8 sends an email request to a first party. The email request contains embedded therein a hyperlink to a web-page interface of the real-time organizational module 8. In process block 11, the first party links to the web site interface the real-time organizational module 8 by use of the embedded hyperlink. In process block 12, the first party answers questions provided by the real-time organizational module 8.

The questions posed by the real-time organizational module 8 are related to the current pulse of the member, the perceived pulse of the organization, an ideal pulse for productivity of that member or other questions related to the pulse of the member. In process block 12, the member is solicited for comments as to the issues affecting their performance.

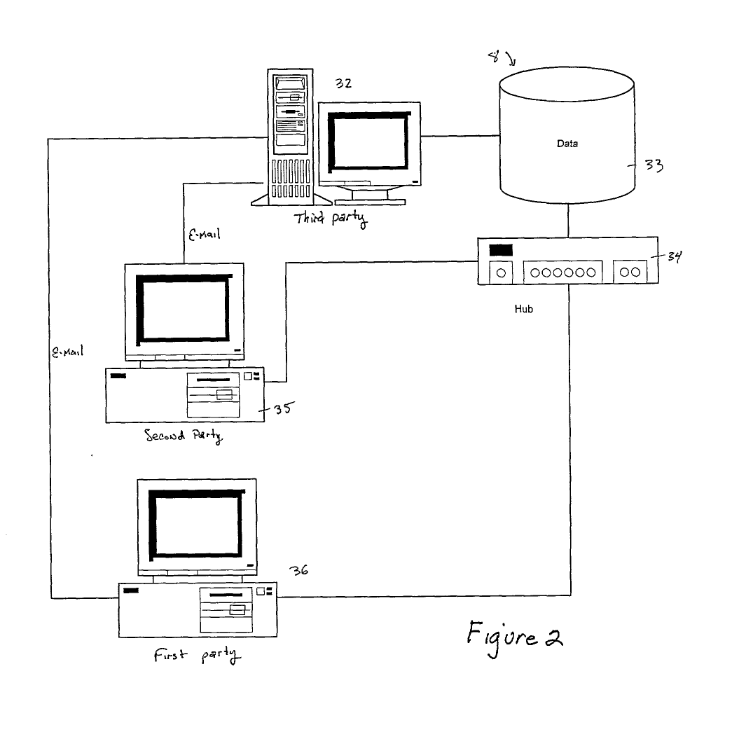

In process block 13, the real-time organizational module 8 retrieves the responses. In process block 14, a third party edits and optionally removes author identifying information and categorizes the remarks made by the first party. In process block 15, the real-time organizational module 8 stores the pulse level and response of the first party in a storage unit 33 (FIG. 2).

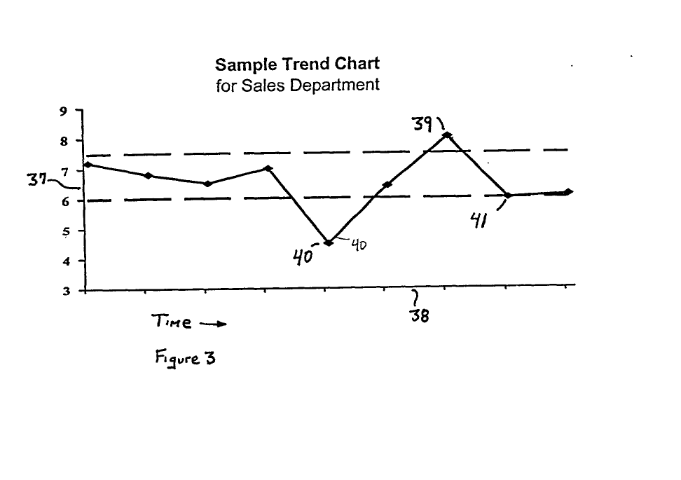

In process block 16, the real-time organizational module 8 queries the storage unit 33 for the average pulse of an organizational group and determines if it falls within specific ranges. The real-time organizational module 8 provides reports to the second party or human resources department based on the energy measurement of organizational groups. Calculations and studies are made to determine whether the pulse of a particular group falls outside of one standard deviation of the ideal pulse level for productivity for a group or individual (see FIG. 3). Should a pulse for a given organizational group or individual begin to vary significantly from high values to low values, a clear indication that there is a “problem” within the organization is indicated. At this point, the second party, human resources, and/or the member are alerted to the problem and may be given recommended methods for dealing with the particular problems seen.

After the real-time organizational module 8 stores the data in process block 15, an evaluation is made whether an emergency is occurring in process block 18. For example, the system may detect any comment that a particular member is suffering from sexual or racial harassment. In this case, the system will contact a human resource manager in process block 19 who can directly address the issue. Should the system determine that there is not an emergency situation in process block 18, the real-time organizational module 8 will provide to the web site a report of the first party's comments in process block 20. The real-time organizational module 8 then will send an email to a second party in process block 21. Optionally, the real-time organizational module 8 will also provide the best responses to the first party in process block 22, or gather more information to assist in the facilitation of communication with the organization.

Optionally, responses by the first party can be stripped of any identifying information and forwarded directly to the second party. In addition, it is possible for the third party to skip sending the first party any information with respect to the responses.

Upon receiving the email from process block 21, the second party will visit the real-time organizational module 8 web site. In process block 23, the second party will visit the web site and receive the comments by the first party, as well as the optional best responses 24. In decision block 25, the second party determines whether a response to the first party is necessary. Should the second party determine that no response is needed, the flow chart ends at block 26.

Should the second party determine that a response to the first party is necessary, the second party responds at the real-time organizational module's web site at process block 27 with either the provided best response or a custom response. Either the second party or optionally the third party can respond to the comments or concerns of the first party. The real-time organizational module 8 sends an email to the first party in process block 28. The first party receives the email in process block 29 and links to the real-time organizational module 8 in process block 30 to receive the best or custom response.

In decision block 31, the first party respondent determines whether a further response to the second party's response is warranted. Should no response be warranted, the flow chart ends at 26. Should the first party determine that a response is necessary, the first party will re-file a response in process block 31, the flow chart again returns to process block 12 where the real-time organizational module 8 retrieves the response, optionally, removes any references to the first party, and further categorizes the response. Optionally, the reporting function can be independent of the flow of information from the first to second parties.

FIG. 2 is a block diagram of the computer systems of the present invention. Shown is the real-time organizational module 8 stored within a computer 32. The computer 32 runs statistical analysis and provides an interface for the third party to manage responses from the first and second parties. This includes removing references to the responses, as well as categorizing the responses within different levels. The computer 32 also is used to determine which of the “best responses” would optimally be provided to a second party in response to a first party's comments.

The computer 32 further has the database structure 33, which stores the responses and the anonymous links between the parties. The computer 32 further controls a web site interface 34 which is used to manage the requests by an entity for a survey as in process block 9 retrieving answers to questions by the first party responder in process block 12 and providing a response to the second party evaluated person, as in process block 22.

Computer 32 further manages the emailing of notifications of surveys, as in process block 10, as well as notifications of reports, such as in process block 17, 20 or 31. Shown is the first party's computer 35 for receiving the emails and interfacing with the web site interface 34.

Computer 32 is used by the second party to receive or send emails to the real-time organizational module 8. The computer 32 also allows the second party to access the Internet to evaluate reports provided by the real-time organizational module 8 or to review responses from the first party.

FIG. 3 represents a typical plot of the change within an organization, which can be developed by measuring the pulse of an organization over time. Shown is a sample chart of the pulse of a sales team. The vertical axis 37 represents the measured pulse for a given sales department. Shown on the horizontal axis 38 is the date in which the pulses were measured. Line 39 represents a change in the pulse of a sales department over time. As an example of a hypothetical sales department, the pulse of a group is shown to swing up and down. Significant oscillations in the pulse of a member can be expected when a member is under considerable stress such as changes in an incentive plan or the change of leadership within a department (for example, between points 39 and 40). As can be seen at point 41, reductions in oscillations of a pulse of an organization can be expected when corrections to the perceived problems can be addressed.

The system specifically looks for pulse values at the extremes of the scale. It additionally monitors and analyzes changes and the rates of change in the pulse responses in calculating an evaluation of an organizational entity.

The foregoing discussion discloses and describes merely exemplary embodiments of the present invention. One skilled in the art will readily recognize from such discussion, and from the accompanying drawings and claims that various changes, modifications and variations can be made therein without departing from the spirit and scope of the invention.

What is claimed is:

1. A method of predicting and influencing the performance of an organization comprising the steps of:
initiating a survey with an independent third party;
sending a first correspondence from the independent third party to a member of the organization;
providing an independent third party web site;
asking the member of the organization at least one question related to the individuals energy level at the web site;
accessing the independent third party's web site by the member of the organization and responding thereto;
sending the member's comments and responses to a database; and
analyzing the comments by the independent third party.

2. The method of claim 1 further comprising the step of the independent third party providing advice to the organization on how to respond to the member's comments.

3. The method of claim 1 further comprising the steps of:
preparing a report from the comments;
sending the report to the web site;
notifying the organization that a report is available;
retrieving the report by the organization at the independent third party's web site; and
sending a second correspondence from the independent third party to the member of the organization.

4. The method of claim 3 wherein sending a report includes the step of calculating changes in a member's pulse.

5. The method of claim 3 wherein sending a report includes the step of determining whether a significant change has occurred to the pulse of the organization.

6. The method of claim 3 wherein sending a report includes the step of determining whether a significant change has occurred in the pulse of the member.

7. The method of claim 3 wherein sending a report includes the step of providing a set of best possible responses to the member's comments.

8. The method of claim 3 wherein sending a report includes the step of editing responses to remove a member's identity.

9. The method of claim 3 wherein sending a report includes the step of categorizing comments.

10. The method of claim 9 wherein categorizing comments includes using an expert system.

11. The method of claim 3 further including the step of the second party providing a response to the member of the organization by forwarding it through the independent third party.

12. The method of claim 11 further including the step of the independent third party contacting the member of the organization to let them know a response has been provided.

13. The method of claim 1 further comprising the step of providing a computer system having a member interface, an organization interface, and an independent third party interface.

14. A method of measuring the pulse of an individual comprising the steps of:
providing a web site including questions which correlate to the individual's pace of work, efficiency of work, and job satisfaction;
sending a first electronic message requesting that the individual answer the questions on the web site; and
recording a first response to said questions.

15. The method of claim 14 further comprising the step of sending at least a second electronic message requesting the individual participate in a subsequent survey, and comparing said first response to said first survey to said subsequent response to determine changes in the response to the individual over time.

16. The method of claim 14 wherein providing a web site further includes the step of providing a web site run by a third party, said third party keeping said responses secure.

17. The method of claim 16 further comprising the step of providing said first response to a second party.

18. The method of claim 17 wherein either said second party or said third party forwards a second response to said web site and said first party can access said second response.

19. The method of claim 16 wherein said individual and said second party are anonymous to each other, in that responses from said individual are not identified by name and are aggregated with others'.

20. The method of claim 19 wherein said third party may or may not know the identity of said individual and said second party.

21. The method of claim 19 wherein said third party provides said second party best responses to said first response.

22. The method of claim 14 further comprising the step of sending an electronic message to any sub-set of individuals within an organizational structure.

23. The method of claim 22 wherein third party compiles responses to said electronic message and forwards the compiled responses to at least one second individual within an organizational structure.

24. The method of claim 17 further comprising the step of providing an expert system.

25. The method of claim 24 further comprising the steps of said expert system providing analysis and best responses to said first party or to said second party.

26. The method of claim 14 comprising the step of producing a report based upon said first response and training individuals using said report.

27. A system operable on one or more computers for generating a pulse of an organization, said system comprising:
a database operable to store survey data representing the pace of work, efficiency at work, job satisfaction within the organization, and comments related to issues affecting performance;
a real-time organizational module coupled to said database and operable to request individuals within the organization to provide said survey data, the real-time organizational module operable to electronically communicate with the individuals within said organization, said real-time organizational module further being capable of segmenting said survey data into a plurality of survey data segments; and
calculating an organizational energy variable based upon the data in the plurality of data segments.

28. The system of claim 27 further comprising a data set of best responses.

29. The system of claim 27 wherein the said real-time organizational module is capable of forwarding said individual's survey data to a second party.

30. The system of claim 28 wherein said real-time organizational module is capable of providing said best responses to said second party.

31. The system of claim 29 wherein said real-time organizational module is capable of providing second responses from said second party to said individuals while said individual remains anonymous to said second party.

32. The system of claim 29 wherein said real-time organizational module is capable of providing direction to information related to issues of interest to the organization.

33. The system of claim 29 wherein said real-time organizational module is an expert system.
